(19) United States
(12) Patent Application Publication
(10) Pub. No.: US 2022/0121433 A1
(43) Pub. Date: Apr. 21, 2022

(54) INSTALLATION APPARATUS AND METHOD

(71) Applicant: Preferred Networks, Inc., Tokyo (JP)

(72) Inventor: Tobias PFEIFFER, Tokyo (JP)

(21) Appl. No.: 17/072,220

(22) Filed: Oct. 16, 2020

(51) Int. Cl. G06F 8/61; G06F 16/901

(52) U.S. Cl. CPC G06F 8/61; G06F 16/9024

(57) ABSTRACT

An installation apparatus including one or more memories that store subgraphs for features, each of the subgraphs representing a dependency of nodes required for installation of the corresponding feature, and one or more processors that are configured to obtain a set of to-be-installed features, construct, a graph from subgraphs for the set of to-be-installed features, and determine an installation order of nodes for the set of to-be-installed features based on the graph is disclosed.

### BACKGROUND

### 1. Technical Field

The disclosure herein relates to an installation apparatus and an installation method.

### 2. Description of the Related Art

There are occasions where users may be required to install a large number of software packages or programs into hardware resources, such as a computer or a server, for use of features or functions that need to implement desired tasks. Typically, one or more of the software packages or programs may need to be installed after installation of others. In other words, the users may be required to install the software packages or programs in a certain installation order.

### SUMMARY

The present disclosure relates to an installation technique for installing software packages or programs in an appropriate or efficient installation order.

One aspect of the present disclosure relates to an installation apparatus, comprising: one or more memories that store subgraphs for features, each of the subgraphs representing a dependency of nodes required for installation of the corresponding feature; and one or more processors that are configured to: obtain a set of to-be-installed features; construct a graph from subgraphs for the set of to-be-installed features; and determine an installation order of nodes for the set of to-be-installed features based on the graph.

Another aspect of the present disclosure relates to an installation method, comprising: obtaining, by one or more processors, a set of to-be-installed features; constructing, by the one or more processors, a graph from subgraphs for the set of to-be-installed features, wherein each of the subgraphs represents a dependency of nodes required for installation of the corresponding feature; and determining, by the one or more processors, an installation order of nodes for the set of to-be-installed features based on the graph.

### BRIEF DESCRIPTION OF THE DRAWINGS

Other objects and further features of the present disclosure will be apparent from the following detailed description when read in conjunction with the accompanying drawings, in which:

FIG. 1 is a sematic diagram for illustrating an installation apparatus according to one embodiment of the present disclosure;

FIG. 2 is a block diagram for illustrating a functional arrangement of the installation apparatus according to one embodiment of the present disclosure;

FIGS. 3A to 3D illustrate subgraphs for packages required to install respective features according to one embodiment of the present disclosure;

FIG. 4 illustrate a subgraph for packages required to install a feature and a graph composed of the subgraphs according to one embodiment of the disclosure;

FIG. 5 is a flowchart for illustrating a feature installation operation according to one embodiment of the present disclosure;

FIG. 6 is a pseudo code for installing features according to one embodiment of the present disclosure;

FIG. 7 illustrates a subgraph for “chainer” feature according to one embodiment of the present disclosure;

FIG. 8 illustrates a subgraph for “mvapich2” feature according to one embodiment of the present disclosure;

FIGS. 9A and 9B illustrate subgraphs for “apt:nano” and “pip:click” features according to one embodiment of the present disclosure;

FIG. 10 illustrates a graph constructed from the subgraphs for the features according to one embodiment of the present disclosure;

FIG. 11 is a schematic diagram for illustrating a package installation operation according to one embodiment of the present disclosure;

FIG. 12 is a schematic diagram for illustrating a package installation operation according to one embodiment of the present disclosure;

FIG. 13 is a schematic diagram for illustrating a package installation operation according to one embodiment of the present disclosure;

FIG. 14 is a schematic diagram for illustrating a package installation operation according to one embodiment of the present disclosure;

FIG. 15 is a schematic diagram for illustrating a package installation operation according to one embodiment of the present disclosure;

FIG. 16 is a schematic diagram for illustrating a package installation operation according to one embodiment of the present disclosure;

FIG. 17 is a pseudo code for installing features according to one embodiment of the present disclosure;

FIG. 18 illustrates a subgraph for “mvapich2” according to one embodiment of the present disclosure;

FIG. 19 illustrates a graph constructed from the subgraphs for the features according to one embodiment of the present disclosure; and

FIG. 20 is a block diagram for illustrating a hardware arrangement of the installation apparatus according to one embodiment of the present disclosure.

### DESCRIPTION OF THE PREFERRED EMBODIMENTS

Embodiments of the present disclosure are described below with reference to the drawings. The same or like reference numerals may be attached to components having substantially the same functionalities and/or structures throughout the specification and the drawings, and descriptions thereof may not be repeated.

### Overview

In embodiments below, an installation apparatus that upon receiving an installation request for features, libraries, modules or functions (which are collectively referred to as features hereinafter), may determine an installation order of packages or programs required to install the requested features into one or more computers or servers is disclosed. The installation apparatus may store subgraphs provided for the respective features beforehand, and the respective subgraphs are ordered graphs that may represent dependencies or installation order of the required packages or programs.

For example, it is supposed that three packages A, B and C need to be installed for installation of feature X. Then, if package A required to install feature X needs to be installed before installation of package B, the subgraph for feature X would include a directed edge from (package) node A to (package) node B. Analogously, if package A needs to be installed before installation of package C, the subgraph for feature X would also include another directed edge from (package) node A to (package) node C. In other words, the subgraph would be of a directed tree structure having the single root node A and the two leaf nodes B and C branched from the root node A. In this manner, if a single feature is installed, we only have to install packages or programs required to install the single feature in accordance with its subgraph provided beforehand.

Meanwhile, users may often need to install several features into a computer to cause the computer to execute a desired task. In general, the more complicated the desired task is, the more features may need to be installed. In this case, even if we have respective subgraphs for the features, we may not be able to determine the installation order of packages required to install the features easily. Also, the subgraphs may include one or more duplicated packages, and if straightforward installation, for example, sequential installation of individual features, is performed, duplicated installation for the packages may unnecessarily occur.

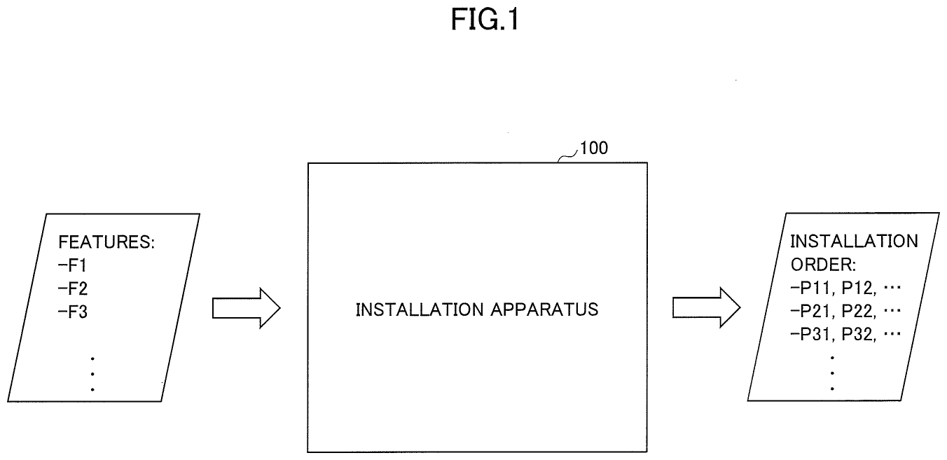

An installation apparatus according to embodiments of the present disclosure may determine the installation order of the packages based on a directed graph constructed from the respective subgraphs of the to-be-installed features. According to the installation apparatus, even if a large number of features are installed, the installation order of the required packages may be determined based on the constructed graph. For example, as illustrated in FIG. 1, an installation apparatus 100 according to one embodiment of the present disclosure may receive incoming features F1, F2, F3, . . . for one or more desired tasks and determines an installation order P11, P12, . . . ; P21, P22, . . . ; P31, P32, . . . ; . . . of packages required for installation of the features. According to the determined installation order, a first set of packages P11, P12, . . . may need to be first installed. Note that packages P11, P12, . . . in the first set of packages may be installed in any order. Then, a second set of packages P21, P22, . . . may need to be installed, a third set of packages P31, P32, . . . may need to be then installed, and so on.

### Installation Apparatus

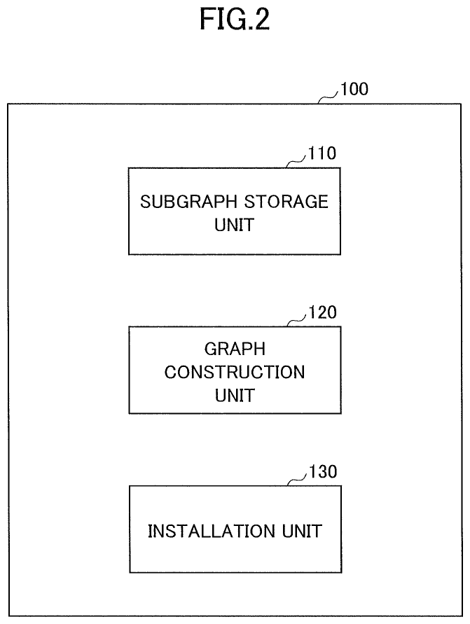

The installation apparatus 100 according to one embodiment of the present disclosure is described with reference to FIGS. 2 to 4. FIG. 2 is a block diagram for illustrating a functional arrangement of the installation apparatus 100 according to one embodiment of the present disclosure.

As illustrated in FIG. 2, the installation apparatus 100 may include a subgraph storage unit 110, a graph construction unit 120 and an installation unit 130.

The subgraph storage unit 110 may store subgraphs for features. Each of the subgraphs may represent a dependency or an installation order of packages required for installation of the corresponding feature. The feature may be also referred to as a function, a library, a module or the like.

Typically, one or more packages may need to be installed in a predetermined installation order for installation of the feature. The installation order (dependency) of packages required to install the feature may be represented with a directed subgraph. The directed subgraph may comprise nodes representing the individual packages and directed edges from node A to node B if package A needs to be installed before package B. For each feature, the subgraph storage unit 110 may store its subgraph beforehand.

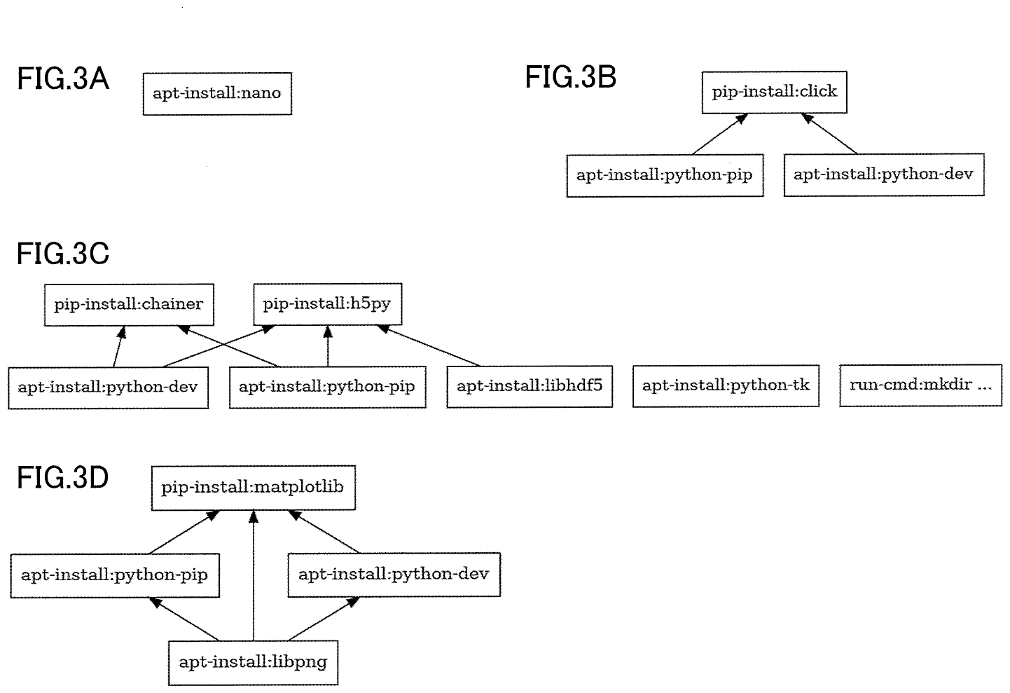

For example, the subgraph storage unit 110 may store subgraphs as illustrated in FIG. 3A to FIG. 3D. The four subgraphs correspond to packages and installation orders for three features “nano”, “click” and “chainer”.

As illustrated in FIG. 3A, the “nano” feature may have a single-node subgraph and may be installed by installing the single apt package “nano”.

As illustrated in FIG. 3B, the “click” feature may have a subgraph having three nodes and two directed edges. According to the subgraph, the “click” feature may be installed by installing the two apt packages “python-pip” and “python-dev” first and then the pip package “click”.

As illustrated in FIG. 3C, the “chainer” feature may have a subgraph having seven nodes and five directed edges. According to the subgraph, the “chainer” feature may be installed by installing the four apt packages “python-dev”, “python-pip”, “libhdf5”, and “python-tk” first and then the two pip packages “chainer” and “h5py”. Also, a “mkdir” command may be executed. Note that the installation of the apt package “python-tk” and the execution of “mkdir” may be performed independently of the other five packages.

Although the subgraphs as stated above may be predetermined and provided, the subgraphs may be defined and provided by users. In other words, the dependency of packages required for installation of features may be defined or provided by users. As illustrated in FIG. 3D, the dependency or subgraph of packages may be defined by a user. In the illustrated subgraph, the user may define that apt package “libpng” may be first installed, apt packages “python-pip” and “python-dev” must be then installed, and pip package “matplotlib” must be finally installed. The subgraph storage unit 110 may store the user's defined subgraphs.

The graph construction unit 120 may obtain a set of to-be-installed features and constructs a graph from subgraphs for the set of to-be-installed features. In one embodiment, the graph construction unit 120 may construct the graph as a union of the subgraphs.

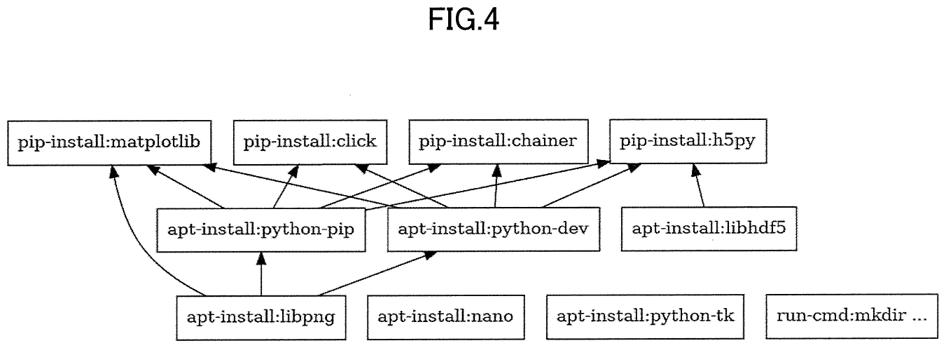

Specifically, upon obtaining a set of features for installation from a user, the graph construction unit 120 may combine the subgraphs for the to-be-installed features to construct a graph. For example, when the user selects the four features or subgraphs for installation as illustrated in FIGS. 3A to 3D, the graph construction unit 120 may fetch the four subgraphs from the subgraph storage unit 110 and combines the four subgraphs in accordance with any graph construction method or algorithm. For example, if a node or package is shared between two of the subgraphs, the graph construction unit 120 may combine the two subgraphs by using the shared node or package as the connection node or package. The packages “python-pip” and “python-dev” may be found in the three subgraphs as illustrated in FIGS. 3B and 3C and FIG. 3D. The graph construction unit 120 may combine the three subgraphs through the nodes or packages “python-pip” and “python-dev” to construct a larger subgraph from the three subgraphs. Also, the graph construction unit 120 may further combine the combined larger graph with the subgraph in FIG. 3A to construct a graph as illustrated in FIG. 4B. Note that if a node or package may have no dependency on other nodes or packages, the node or package would become an isolated node such as apt packages “nano” and “python-tk” and command “mkdir” as illustrated in FIG. 4B.

The installation unit 130 may define an installation order of packages for the set of to-be-installed features based on the graph. Specifically, upon obtaining the graph constructed from the subgraphs of packages for the set of to-be-installed features from the graph construction unit 120, the installation unit 130 may define the installation order of packages for the set of to-be-installed features in accordance with directed paths in the obtained graph.

For example, according to the constructed graph as illustrated in FIG. 4B, although apt packages “nano” and “python-tk” and command “mkdir”, which are isolated nodes in the graph, may be installed in any timing independently of the other packages, package “libpng” needs to be installed before installing packages “python-pip”, “python-dev”, “matplotlib”, “click”, “chainer” and “h5py”. Package “libhdf5” needs to be installed any timing before installing package “h5py”. After installing package “libpng”, the installation unit 130 may install packages “python-pip” and “python-dev” and then install packages “matplotlib”, “click”, “chainer” and “h5py” in accordance with paths outgoing from the installed package or node “libpng”.

### Installation Operation

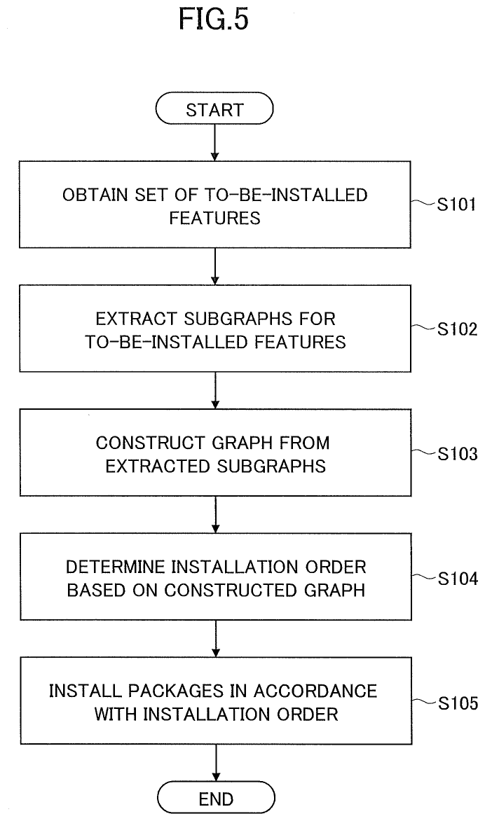

Next, an installation operation according to one embodiment of the present disclosure is described with reference to FIGS. S to 16. The installation operation may be implemented by the above-stated installation apparatus 100, more specifically, by one or more processors executing one or more programs stored in one or more memories in the installation apparatus 100. FIG. 5 is a flowchart for illustrating an installation operation according to one embodiment of the present disclosure.

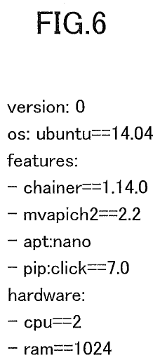

As illustrated in FIG. 5, at step S101, the installation apparatus 100 obtains a set of to-be-installed features. Specifically, the installation apparatus 100 may receive a program code for identifying to-be-installed features as illustrated in FIG. 6. In the illustrated program code, “chainer”, “mvapich2”, “nano” and “click” with their version numbers are described as the to-be-installed features.

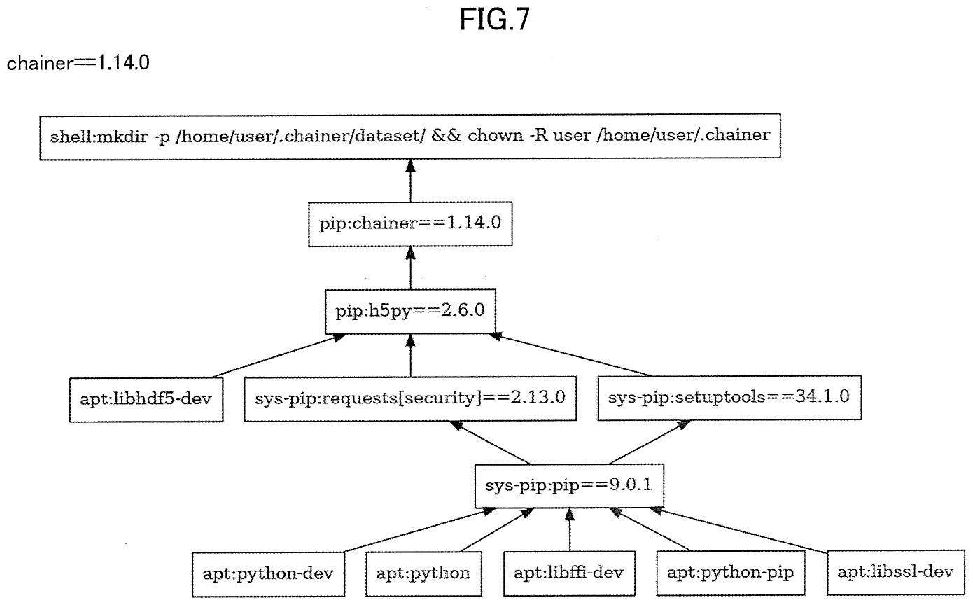

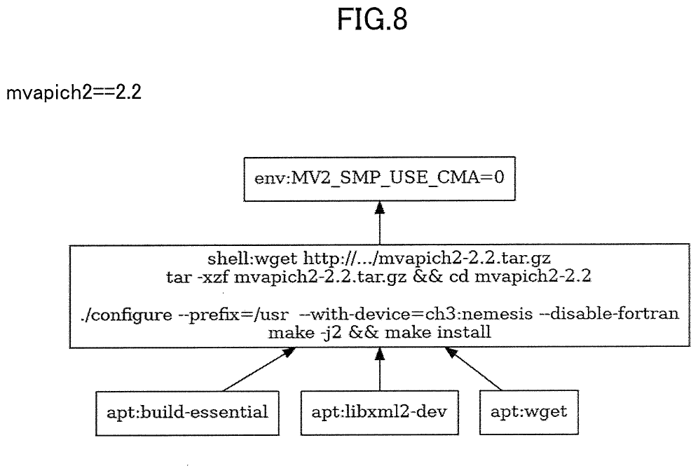

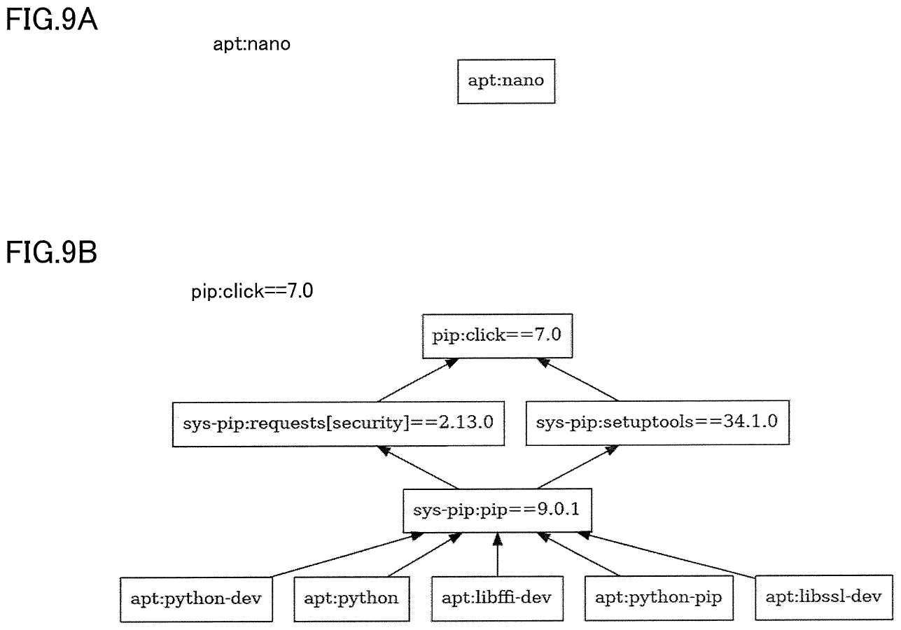

At step S102, the installation apparatus 100 may extract subgraphs of packages for the to-be-installed features. As stated above, the subgraphs of packages may be stored in the installation apparatus 100 beforehand or provided from users, and the installation apparatus 100 may fetch the subgraphs of packages for the to-be-installed features. For example, it is assumed that the installation apparatus 100 may extract the subgraph for feature “chainer” as illustrated in FIG. 7, the subgraph for feature “mvapich2” as illustrated in FIG. 8, and the subgraphs for features “nano” and “click” as illustrated in FIGS. 9A and 9B, respectively.

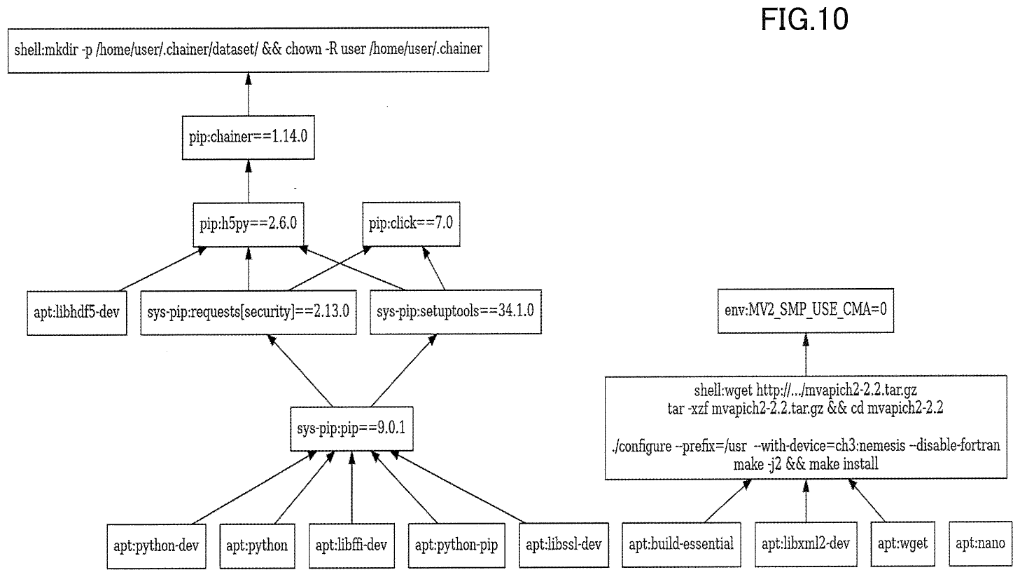

At step S103, the installation apparatus 100 may construct a graph from the extracted subgraphs. For example, it is assumed that the graph as illustrated in FIG. 10 may foe constructed from the subgraphs extracted at step S102. In one embodiment, the installation apparatus 100 may take a union of the extracted subgraphs to construct the graph.

At step S104, the installation apparatus 100 determines the installation order of packages based on the constructed graph.

For example, for the left side of the graph, the installation apparatus 100 may install packages “python-dev”, “python”, “libffi-dev”, “python-pip” and “libssl-dev” in the first bottom layer of the illustrated graph before installation of package “pip” in the second bottom layer. Then, the installation apparatus 100 may install packages “libhdf5-dev”, “requests[security]” and “setuptools” in the third bottom layer. Package “libhdf5-dev” may also be installed at the same timing as the first bottom layer or the second bottom layer. After that, the installation apparatus 100 may install packages “h5py” and “click” in the fourth bottom layer and then package “chainer” in the fifth bottom layer. Finally, the installation apparatus may run command “mkdir” in the top layer. In other words, the installation apparatus 100 may define the installation order in accordance with the layering order from the bottom layer to the top layer:
first, bottom layer: “python-dev”, “python”, “libffi-dev”, “python-pip” and “libssl-dev”;
second bottom layer: “pip”;
third bottom layer: “libhdf5-dev”, “requests[security]” and “setuptools”;
fourth bottom layer: “h5py” and “click”;
fifth bottom layer: “chainer”; and
top layer: “mkdir-p”.

Analogously, for the right side of the graph, the installation apparatus 100 may define the installation order in accordance with the layering order from the bottom layer to the top layer:
first bottom layer: “build-essential”, “libxml2-dev” and “wget”;
second bottom layer: “shell: wget”; and
top layer: “MV2_SMP_USE_CMA”.

Note that package “nano” may be installed in any timing, because the node is an isolated node.

At step S105, the installation apparatus 100 may install the packages for the set of to-be-installed features in accordance with the determined installation order. In the illustrated example, the installation apparatus 100 may install the packages required to install the features “chainer”, “mvapich2”, “nano” and “click” identified with the program code in accordance with the determined installation order. For the illustrated graph, the installation apparatus 100 may install the packages from the first bottom layer to the top layer in accordance with the layering order.

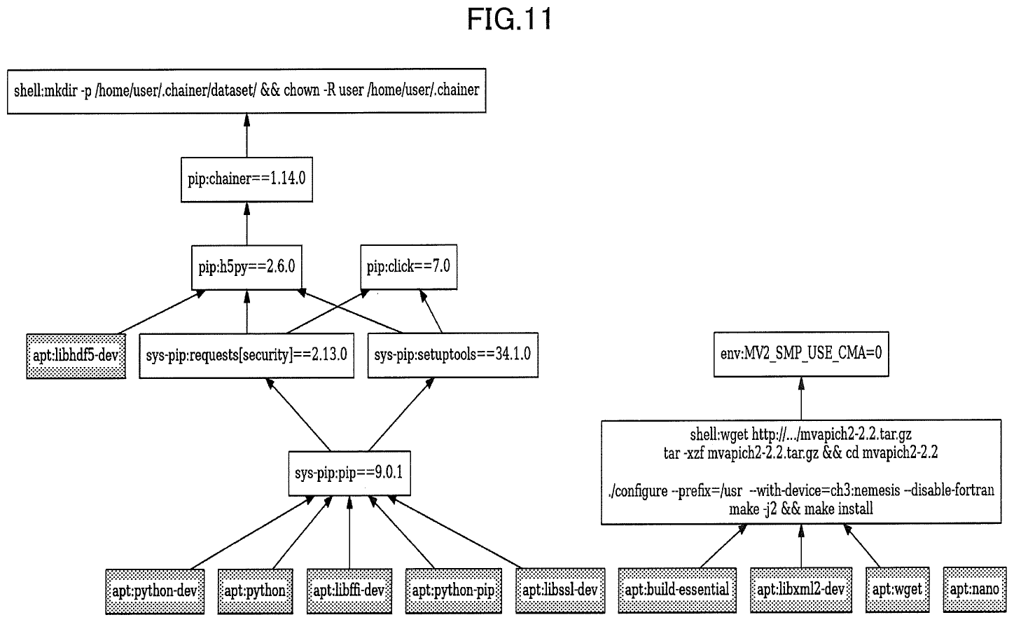

Specifically, as illustrated in FIG. 11, the installation apparatus 100 may first install packages “libhdf5-dev”, “python-dev”, “python”, “libffi-dev”, “python-pip”, “libssl-dev”, “build-essential”, “libxml2-dev”, “wget” and “nano”. Note that these nodes have no incoming edge. After installing the packages, the installation apparatus 100 may delete the installed packages from the graph.

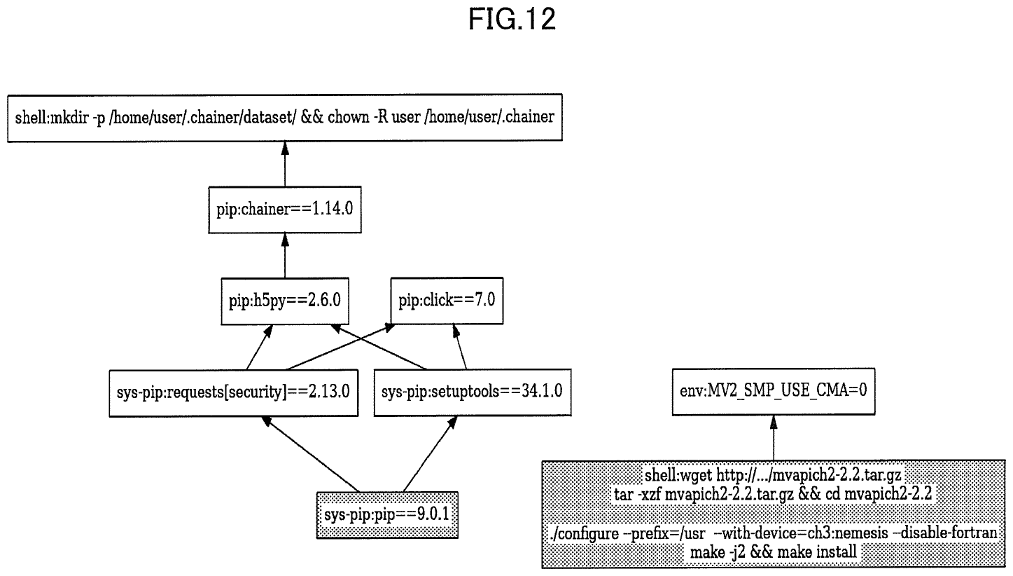

Then, as illustrated in FIG. 12, the installation apparatus 100 may install package “pip” and run the shell command “wget”, which have no incoming edge in the updated graph in FIG. 12. After installing the package and running the shell command, the installation apparatus 100 may further delete the installed packages and command from the updated graph.

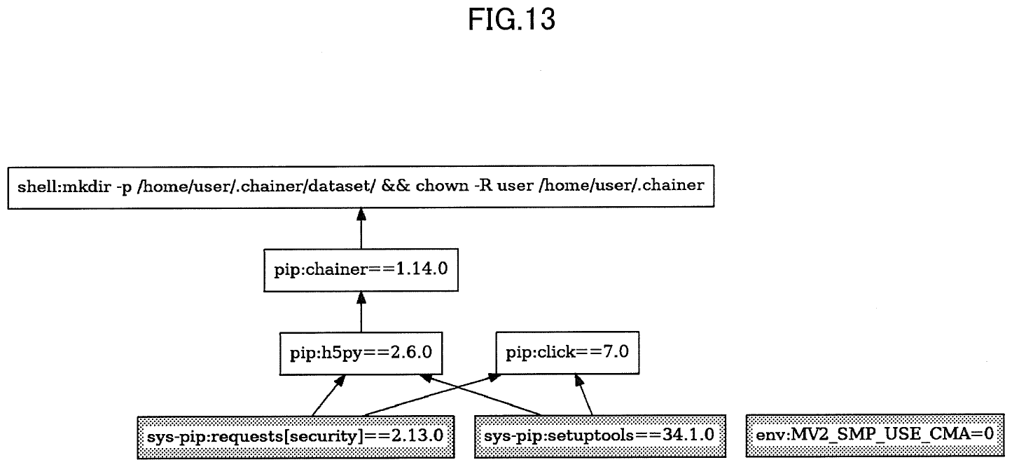

Then, as illustrated in FIG. 13, the installation apparatus 100 may install packages “requests[security]”, “setuptools” and “MV2_SMP_USE_CMA”, which have no incoming edge in the updated graph in FIG. 13. After installing the packages, the installation apparatus 100 may further delete the installed packages from the updated graph.

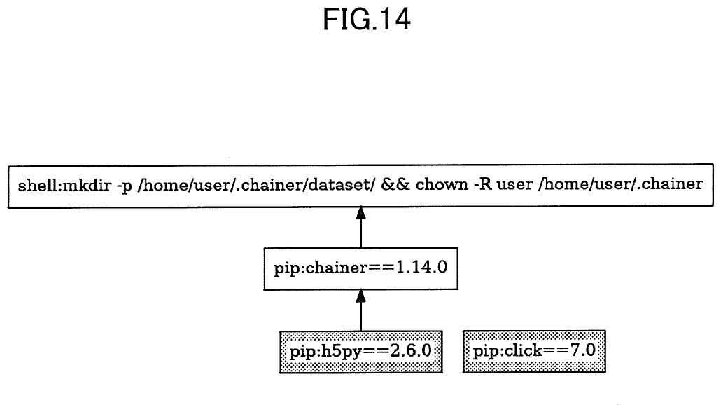

Then, as illustrated in FIG. 14, the installation apparatus 100 may install packages “h5py” and “click”, which have no incoming edge in the updated graph in FIG. 14. After installing the packages, the installation apparatus 100 may further delete the installed packages from the updated graph.

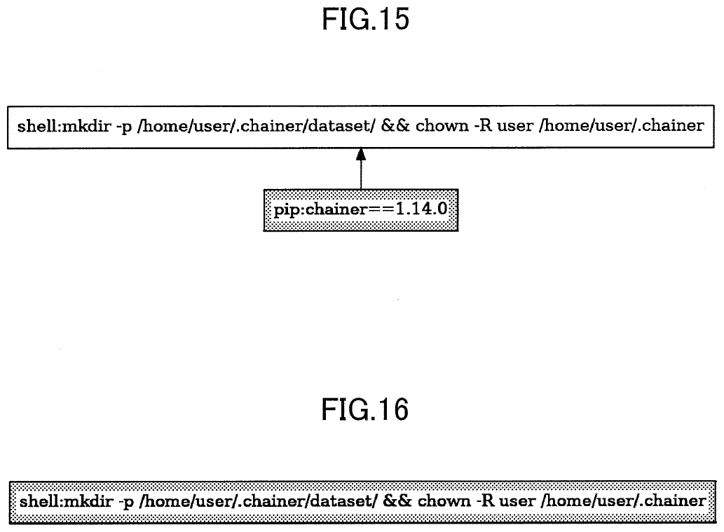

Then, as illustrated in FIG. 15, the installation apparatus 100 may install package “chainer”, which has no incoming edge in the updated graph in FIG. 15. After installing the packages, the installation apparatus 100 may further delete the installed packages from the updated graph.

Finally, as illustrated in FIG. 16, the installation apparatus 100 may run the shell command “mkdir”, which has no incoming edge in the updated graph in FIG. 16. In this manner, the installation apparatus 100 can install all the packages required to install the to-be-installed features.

In one embodiment, different subgraphs for a feature may be provided corresponding to different hardware combinations. In other words, a subgraph for a feature used for installation using one set of hardware resources may be different from a subgraph for that feature used for installation using another set of hardware resources.

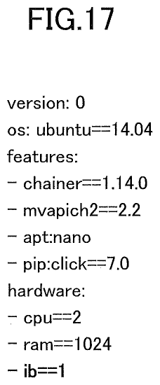

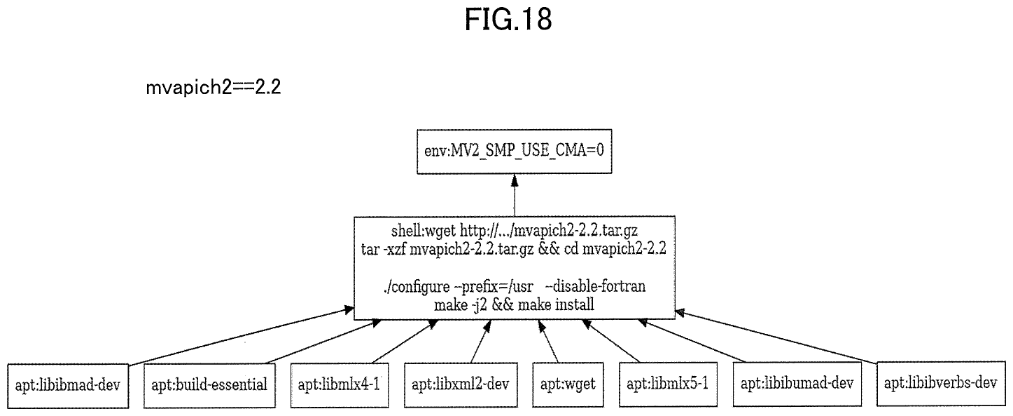

For example, for installation of the same features “chainer”, “mvapich2”, “nano” and “click” for the above installation example, another program code as illustrated in FIG. 17 is provided. Note that in the illustrated program code, a configuration item “ib==1” for Infiniband network is added to the program code in FIG. 6. In other words, according to the program code in FIG. 17, a hardware combination of a CPU, a RAM and an Infiniband network is used to install the above four features. For the hardware combination, a subgraph of packages required to install feature “mvapich2” by means of the hardware resources CPU, RAM and Infiniband network as illustrated in FIG. 18 is provided. It can be seen that compared with the subgraph for feature “mvapich2” as illustrated in FIG. 8, additional packages “libibmad-dev”, “libmlx4-1”, “libmlx5-1”, “libibumad-dev” and “libibverbs-dev” need to be installed for the installation of feature “mvapich2” by means of the hardware resources CPU, RAM and Infiniband network.

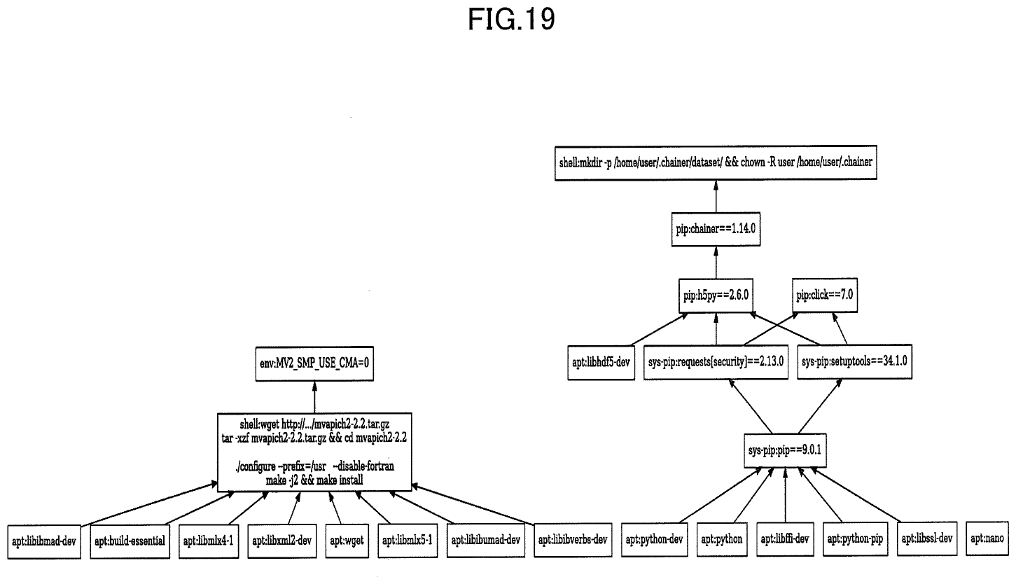

Assuming that the other features “chainer”, “nano” and “click” have the same subgraphs for the different hardware combinations in the program codes in FIGS. 6 and 17, a graph as illustrated in FIG. 19 can be constructed as a union of the four subgraphs. The installation apparatus 100 can install packages required to install the four features in accordance with the constructed graph.

### Hardware Arrangement

The installation apparatus 100 according to the above-stated embodiments may be partially or entirely arranged with hardware resources or implemented with information processing of software items (programs) executed by a CPU (Central Processing Unit), a GPU (Graphics Processing Unit) or the like. If the installation apparatus 100 is implemented with information processing of software items, the information processing of the software items may be performed by storing the software items for implementing at least a portion of the installation apparatus 100 according to the above-stated embodiments in a non-transitory storage medium (non-transitory computer-readable medium) such as a flexible disk, a CD-ROM (Compact Disc-Read Only Memory) or a USB (Universal Serial Bus) memory, and loading them into a computer. Also, the software items may be downloaded via a communication network. Furthermore, the information processing may be executed with hardware resources by embodying the software items in a circuit such as an ASIC (Application Specific Integrated Circuit) or a FPGA (Field Programmable Gate Array).

The type of storage medium for storing the software items is not limited. The storage medium is not limited to removable ones such as a magnetic disk or an optical disk and may be a fixed type of storage medium such as a hard disk or a memory. Also, the storage medium may be internally or externally provided to a computer.

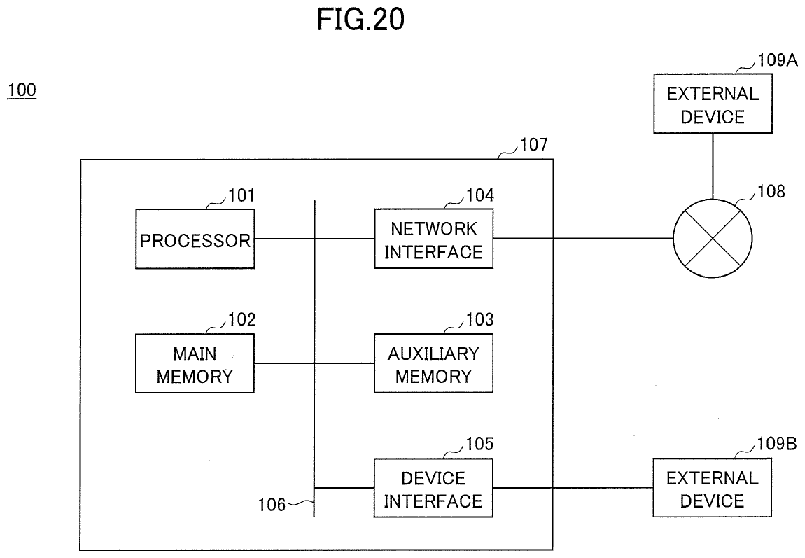

FIG. 20 is a block diagram for illustrating one exemplary hardware arrangement of the installation apparatus 100 according to the above-stated embodiments. As one example, the installation apparatus 100 may have a processor 101, a main storage device (memory) 102, an auxiliary storage device (memory) 103, a network interface 104 and a device interface 105 and may be implemented as a computer 107 by interconnecting them via a bus 106.

The computer 107 in FIG. 20 has the respective components one by one, but a plurality of the same components may be provided. Also, although the single computer 107 is illustrated in FIG. 20, software items may be installed in a plurality of computers, and each of the computers may execute the same or different portions of the software items. In this case, a distributed computing implementation, where the respective computers perform calculations under communication via the network interface 104, is used. In other words, the installation apparatus 100 according to the above-stated embodiments may be composed as a system that implements functionalities by one or more computers running instructions stored in one or more storage devices. Also, the one or more computers provided in a cloud may process information transmitted from a terminal and transmit operational results to the terminal.

Various calculations of the installation apparatus 100 according to the above-stated embodiments may be performed in parallel by means of one or more processors or a plurality of computers via a network. Also, the various calculations may be distributed to a plurality of processing cores in a processor and be performed in parallel. Also, a portion or all of operations, means or the like of the present disclosure may be performed with at least one of the processor or the storage device provided on a cloud that can communicate with the computer 107 via a network. In this manner, the installation apparatus 100 according to the above-stated embodiments may take a parallel computing implementation with one or more computers.

The processor 101 may be an electronic circuitry including a controller and a calculator of the computer 107 (for example, a processing circuitry, a processing circuit, a CPU, a GPU, a FPGA, an ASIC or the like). Also, the processor 107 may be a semiconductor device including a dedicated processing circuitry or the like. The processor 107 is not limited to an electronic circuitry using electronic logic elements and may be implemented with an optical circuitry using optical logic elements. Also, the processor 107 may include calculation functionalities based on quantum computing.

The processor 107 can perform calculations based on data or software items (programs) incoming from internal devices in the computer 107 and output calculation results or control signals to the devices or the like. The processor 107 may perform an OS (Operating System), an application or the like in the computer 107 to control the respective components composing the computer 107.

The installation apparatus 100 according to the above-stated embodiments may be implemented with one or more processors 107. Here, the processor 107 may be one or more electronic circuitries mounted on a single chip or a plurality of electronic circuitries. If the plurality of electronic circuitries, the respective electronic circuitries may communicate in a wired or wireless manner.

The main storage device 102 is a storage device that stores instructions and various data executed by the processor 107, and the processor 107 reads information stored in the main storage device 102. The auxiliary storage device 103 is a storage device other than the main storage device 102. Note that these storage devices mean any electronic component that can store electronic information and may be a semiconductor memory. The semiconductor memory may be a volatile memory or a non-volatile memory. The storage devices for storing various data in the installation apparatus 100 according to the above-stated embodiments may be implemented with the main storage device 102 or the auxiliary storage device 103 or with an internal memory incorporated in the processor 101. For example, storage units according to the above-stated embodiments may be implemented with the main storage device 102 or the auxiliary storage device 103.

A plurality of processors or a single processor may be connected (coupled) to one storage device (memory). A single processor may be connected (coupled) to a plurality of storage devices (memories). If the installation apparatus 100 according to the above-stated embodiments is composed of at least one storage device (memory) and a plurality of processors connected (coupled) to the at least one storage device (memory), at least one of the plurality of processors may be connected (coupled) to at least one storage device (memory). Also, this arrangement may be composed of storage devices (memories) and processors included in a plurality of computers. Furthermore, an arrangement where a storage device (memory) and a processor are integrated (for example, a cache, memory including an L1 cache and an L2 cache) may be included.

The network interface 104 is an interface for connecting to a communication network 108 in a wired or wireless manner. The network interface 104 may be an appropriate interface such as ones compliant with existing communication standards. The network interface 104 may be used to exchange information with an external device 109A connected via the communication network 108. Note that the communication network 108 may be a WAN (Wide Area Network), a LAN (Local Area Network), a PAN (Personal Area Network) or others or combinations thereof and may be any network that enables information to be exchanged between the computer 107 and the external device 109A. One example of the WAN is the Internet or the like, one example of the LAN is IEEE802.11, Ethernet (registered trademark) or the like, and one example of the PAN is Bluetooth (registered trademark), NFC (Near Field Communication) or the like.

The device interface 105 is an interface such as a USB directly connected to an external device 109B.

The external device 109A is connected to the computer 107 via a network. The external device 109B is directly connected to the computer 107.

As one example, the external device 109A or the external device 109B may be an input device. For example, the input device may be a camera, a microphone, a motion capture, various sensors, a keyboard, a mouse, a touch panel or the like and provide obtained information to the computer 107. Also, the external device 109A or the external device 109B may be any device including an input unit, a memory and a processor such as a personal computer, a tablet, a smartphone or the like.

Also, as one example, the external device 109A or the external device 109B may be an output device. For example, the output device may be a display device such as a LCD (Liquid Crystal Display), a CRT (Cathode Ray Tube), a PDP (Plasma Display Panel) or an organic EL (Electro Luminescence) panel or may be a speaker for outputting sound or the like. Also, the external device 109A or the external device 109B may be any device including an output unit, a memory and a processor such as a personal computer, a tablet, a smartphone or the like.

Also, the external device 109A or the external device 109B may be a storage device (memory). For example, the external device 109A may be a network storage or the like, and the external device 109B may be a storage such as a HDD.

Also, the external device 109A or the external device 109B may be a device having a portion of functionalities of the components in the installation apparatus 100 according to the above-stated embodiments. In other words, the computer 107 may transmit or receive a portion or all of operational results of the external device 109A or the external device 109B.

In the specification, the representation “at least one of a, b and c” may include not only combinations a, b, c, a-b, a-c, b-c and a-b-c but also combinations of a plurality of the same elements a-a, a-b-b, a-a-b-b-c-c or the like. Also, the representation may cover arrangements including elements other than a, b and c such as the combination a-b-e-d.

Although the specific embodiments of the present disclosure have been described in detail, the present disclosure is not limited to the specific embodiments as stated above. Various changes, alterations, replacements, partial deletions and so on can be made within the scope of claims and their equivalence.

What is claimed is:

1. An installation apparatus, comprising:
one or more memories that store subgraphs for features, each of the subgraphs representing a dependency of nodes required for installation of the corresponding feature; and
one or more processors that are configured to:
obtain a set of to-be-installed features;
construct a graph from subgraphs for the set of to-be-installed features; and
determine an installation order of nodes for the set of to-be-installed features based on the graph.

2. The installation apparatus as claimed in claim 1, wherein the one or more processors are configured to construct the graph as a union of the subgraphs.

3. The installation apparatus as claimed in claim 1, wherein the one or more memories store different subgraphs for a feature corresponding to different hardware combinations.

4. The installation apparatus as claimed in claim 1, wherein the one or more processors are further configured to install nodes required for installation of the set of to-be-installed features in accordance with the installation order.

5. The installation apparatus as claimed in claim 1, wherein the installation order is determined as one or more paths of directed edges in the graph.

6. The installation apparatus as claimed in claim 1, wherein the nodes are duplicated in the subgraphs, and the nodes are not duplicated in the graph.

7. The installation apparatus as claimed in claim 1, wherein the subgraphs and the graph have edges directed to the nodes, and a subgraph in the subgraphs has a larger number of nodes than the number of edges.

8. The installation apparatus as claimed in claim 7, wherein the installation order of the nodes having no edge is before, after, or between the installation order of all the nodes having edges.

9. The installation apparatus as claimed in claim 1, wherein one or more processors that are further configure to:
install the nodes by layers; and
delete the installed nodes from the graph after installing the nodes in a layer of the layers.

10. The installation apparatus as claimed in claim 1, wherein the subgraphs used for constructing the graph depend on hardware resources.

11. An installation method, comprising:
obtaining, by one or more processors, a set of to-be-installed features;
constructing, by the one or more processors, a graph from subgraphs for the set of to-be-installed features, wherein each of the subgraphs represents a dependency of nodes required for installation of the corresponding feature; and
determining, by the one or more processors, an installation order of nodes for the set of to-be-installed features based on the graph.

12. The installation method as claimed in claim 11, wherein the constructing comprises constructing the graph as a union of the subgraphs.

13. The installation method as claimed in claim 11, wherein different subgraphs are provided for a feature corresponding to different hardware combinations.

14. The installation method as claimed in claim 11, further comprising;
installing, by the one or more processors, nodes required for installation of the set of to-be-installed features in accordance with the installation order.

15. The installation method as claimed in claim 11, wherein the installation order is determined as one or more paths of directed edges in the graph.

16. The installation method as claimed in claim 11, wherein the nodes are duplicated in the subgraphs, and the nodes are not duplicated in the graph.

17. The installation method as claimed in claim 11, wherein the subgraphs and the graph have edges directed to the nodes, and a subgraph in the subgraphs has a larger number of nodes than the number of edges.

18. The installation method as claimed in claim 17, wherein the installation order of the nodes having no edge is before, after, or between the installation order of all nodes having edges.

19. The installation method as claimed in claim 11, further comprising:
installing the nodes by layers; and
deleting the installed nodes from the graph after installing the nodes in a layer of the layers.

20. The installation method as claimed in claim 11, wherein the subgraphs used for constructing the graph depend on hardware resources.
